(19) United States
(12) Patent Application Publication
(10) Pub. No.: US 2012/0026593 A1
(43) Pub. Date: Feb. 2, 2012

(54) MICROLENS ARRAY MANUFACTURING METHOD, AND MICROLENS ARRAY

(75) Inventors: Shota Yoshimura, Hyogo (JP); Masaru Sasaki, Hyogo (JP)

(73) Assignee: TOKYO ELECTRON LIMITED, Minato-ku, Tokyo (JP)

(21) Appl. No.: 13/258,651

(22) PCT Filed: Mar. 11, 2010
(86) PCT No.: PCT/JP2010/054102

§ 371 Date: Oct. 24, 2011

(30) Foreign Application Priority Data
Mar. 25, 2009 (JP) 2009-074388

(51) Int. Cl. G02B 27/12; C23F 1/00

(52) U.S. Cl. 359/619; 216/26

(57) ABSTRACT

There is provided a manufacturing method for a microlens array including a multiple number of microlenses protruded in a substantially hemispherical shape from a surface. The manufacturing method includes forming a resist layer for forming a shape of the microlenses on an organic film layer serving as a material layer of the microlenses; and etching the formed resist layer and the organic film layer by using a mixed gas including hydrogen-containing molecules and fluorine-containing molecules.

### TECHNICAL FIELD

The present invention relates to a microlens array manufacturing method and a microlens array. In particular, the present invention relates to a microlens array manufacturing method by etching an organic film to manufacture a microlens, and a microlens array.

### BACKGROUND ART

As one of the components constituting a CCD (Charge Coupled Device), there is a microlens array in which multiple microlenses are arranged in a matrix shape. Each of the multiple microlenses is protruded in a substantially hemispherical shape, and the multiple microlenses are arranged in juxtaposition on a plane in a longitudinal and transverse directions.

This type of the microlens array can be manufactured by etching an organic film layer serving as a material layer of the microlenses. A technique of manufacturing a microlens array is described in Japanese Patent Laid-open Publication No. H10-148704 (Patent Document 1).

Patent Document 1: Japanese Patent Laid-open Publication No. H10-148704

### DISCLOSURE OF THE INVENTION

### Problems to Be Solved by the Invention

A conventional microlens array manufacturing method will be explained briefly. Above all, a color filter layer is formed on a silicon substrate and an organic film layer serving as a material of a microlens is formed thereon. Further, a resist layer having a rectangular cross sectional shape is formed on the organic film layer as a mask layer. Then, a reflow process is performed on the formed resist layer so as to have a microlense pattern. The resist layer is protruded in a substantially hemispherical shape from an upper surface of the organic film layer.

FIG. 14 is a schematic cross sectional view showing a microlens array workpiece 101 manufactured as described above. FIG. 14 shows the cross sectional view of the microlens array workpiece 101 in a thickness direction. Further, in FIG. 14, and FIGS. 15, 2, 4, 5 and 6, which will be described later, up and down directions on the paper will be described as a thickness direction of a substrate, i.e. a vertical direction, and right and left directions on the paper will be described as a horizontal direction.

Referring to FIG. 14, as described above, the microlens array workpiece 101 includes a silicon layer 102, a color filter layer 103, an organic film layer 104, and a resist layer 105 in a bottom-up sequence. A reflow process is performed on the resist layer 105 such that its upper surface 106 is protruded in a substantially hemispherical shape. Further, the resist layer 105 formed on an upper surface 107 of the organic film layer 104 will be etched in a later process, and, thus, the resist layer 105 is made of an organic material like the organic film layer 104.

An etching process is performed on the microlens array workpiece 101 formed as described above. The etching process is performed so as to etch both the organic film layer 104 and the resist layer 105 protruded in a substantially hemispherical shape. That is, at a position where the resist layer 105 is formed, the protruded shape remains selectively. In this way, a microlens has a configuration protruded in a substantially hemispherical shape.

FIG. 15 is a schematic cross sectional view of a microlens array 111 in case the etching process is finished. Referring to FIGS. 14 and 15, the microlens array 111 includes the silicon layer 102, the color filter layer 103, and the organic film layer 104 in a bottom-up sequence. The resist layer 105 depicted in FIG. 14 is etched. Further, on a surface of the organic film layer 104, a microlens 108 is formed in a shape of the resist layer 105 protruded in a substantially hemispherical shape.

It is desirable for a height of the microlens, i.e. a vertical length of the microlens, to be as great as possible. That is, the greater the height of the microlens is, the more hemispherical the configuration of the microlens becomes. As a result, a light collection efficiency at the microlens is improved. Thus, it is required to further increase the height of the microlens. Further, in a microlens array manufacturing method, it is desirable to readily adjust a height of a microlens as a required level. Here, referring to FIG. 15, the height of the microlens, i.e. the vertical length of the microlens, indicates a vertical length H measured from a horizontal end 109 as a lowermost portion of the microlens 108 to a vertex 110, which is protruded in a substantially hemispherical shape, as an uppermost portion of the microlens 108 on the upper surface of the etched organic film layer 104.

In Patent Document 1, it is described that only a freon-based gas such as CF₄, C₂F₆, and C₃F₈ is used as an etching gas. Further, it is described that as a substitute for the freon-based gas, a halogen gas such as Cl₂, HCl, HBr, and BCl₃ or a nitrogen oxide-based gas such as N₂, CO, and CO₂ can be used. However, if such an etching gas is used, since an organic film layer and a resist layer serving as material layers have low etching selectivity to each other, it is difficult to obtain a microlens of high height. That is, since the organic film and the resist film are etched at a approximately same processing rate, there is a possibility that a height of the microlens can be decreased. Further, it is very difficult to adjust the height of the microlens by this method.

The present invention provides a microlens array manufacturing method in which a height of a microlens can be readily adjusted.

Further, the present invention provides a microlens array including microlenses of high height.

### Means for Solving the Problems

In accordance with one aspect of the present invention, there is provided a manufacturing method for a microlens array including a multiple number of microlenses protruded in a substantially hemispherical shape from a surface. The method includes forming a resist layer for forming a shape of the microlenses on an organic film layer serving as a material layer of the microlenses; and etching the formed resist layer and the organic film layer by using a mixed gas including hydrogen-containing molecules and fluorine-containing molecules.

In accordance with this microlens array manufacturing method, it becomes easy to adjust a height of a microlens. It seems that there are the following two reasons. Further, it does not matter which one of these two reasons is dominant.

First, hydrogen dissociated from hydrogen-containing molecules in an etching gas may react with an organic material constituting a resist layer on a surface of the resist layer. Then, a generated reaction product may protect the surface of the resist layer to some extend and reduce an etching rate of the resist layer. As a result, an amount of an organic film layer remaining on a region below the resist layer is increased, and, thus, it is possible to increase a height of the microlens.

Second, when fluorine is dissociated from fluorine-containing molecules in the etching gas, the fluorine may have a strong etching property on an etching target material. Here, the above-described mixed gas may enable the dissociated fluorine to react with the hydrogen dissociated from the hydrogen-containing molecules and to become HF. An amount of the fluorine may be decreased when the fluorine having a high etching rate is combined with the hydrogen dissociated from the hydrogen-containing molecules. Further, a physical etching process may be mainly performed rather than a chemical etching process with dissociated fluorine. Accordingly, it is possible to prevent the resist layer to being removed early, i.e. immediately removed by a chemical etching. As a result, an amount of an organic film layer remaining on the region below the resist layer is increased, and, thus, it is possible to increase the height of the microlens.

In this case, by adjusting a flow rate ratio of the hydrogen-containing molecules to fluorine-containing molecules in the mixed gas supplied during the etching process or by adjusting components of the molecules, it is possible to adjust the height of the microlens. Therefore, it can be easy to adjust the height of the microlens, i.e. a vertical length of the microlens. Further, it is possible to manufacture a microlens of a high height as required.

Forming a resist layer may include forming the resist layer protruded in a substantially hemispherical shape.

In the mixed gas, the hydrogen-containing molecules may have a gas flow rate of about 30 sccm or higher.

When etching the formed resist layer and the organic film layer, an internal pressure of a processing chamber may be about 200 mTorr or lower.

Further, in the mixed gas, a ratio of the hydrogen-containing molecules to the fluorine-containing molecules may be in a range of from about 1:2 to about 1:15.

The hydrogen-containing molecules may include HBr.

Further, the fluorine-containing molecules may include multiple freon-based gases represented by structural formula CxFy (x and y are integers greater than or equal to 1).

The fluorine-containing molecules may include CF₄ and C₄F₈, and a flow rate ratio of the CF₄ to the C₄F₈ is in a range of from about 2:1 to about 15:1.

Further, etching the formed resist layer and the organic film layer may be performed by using microwave plasma of which a plasma source is microwave.

In accordance with another aspect of the present invention, there is provided a microlens array including a multiple number of microlenses protruded in a substantially hemispherical shape from a surface. The microlens array may be manufactured by forming a resist layer for forming a shape of the microlenses on an organic film layer serving as a material layer of the microlenses; and by etching the formed resist layer and the organic film layer by using a mixed gas including hydrogen-containing molecules and fluorine-containing molecules.

In accordance with still another aspect of the present invention, there is provided a microlens array including a multiple number of microlenses protruded in a substantially hemispherical shape from a surface. In each of the microlenses, a vertical length from a horizontal end as a lowermost point in a vertical direction to a vertex as an uppermost point protruded in the substantially hemispherical shape may be about 0.3 μm or higher.

In accordance with still another aspect of the present invention, there is provided a microlens array including a multiple number of microlenses protruded in a substantially hemispherical shape from a surface. In each of the microlenses, a ratio of a vertical length to a horizontal length may be in a range of from about 1:2 to about 1:6. The vertical length indicates a height difference between a horizontal end as a lowermost point in a vertical direction and a vertex as an uppermost point protruded in a substantially hemispherical shape, and the horizontal length indicates a length between the horizontal ends.

In accordance with still another aspect of the present invention, there is provided a microlens array including a plurality of microlenses protruded in a substantially hemispherical shape from a surface. When an angle formed by a line extended from a horizontal end of each of the microlenses in a horizontal direction and a tangent line of a spherical surface at the horizontal end of each of the microlenses is denoted by θ, θ may be greater than or equal to about 30 degrees.

### EFFECT OF THE INVENTION

In accordance with a microlens array manufacturing method and a microlens of the present invention, it becomes easy to adjust a height of a microlens included in a microlens array. Therefore, it is possible to easily manufacture a microlens array including microlenses having a required height.

Further, in accordance with a microlens array of the present invention, a height of a microlens is large, and, thus, a light collection efficiency can be improved.

### BRIEF DESCRIPTION OF THE DRAWINGS

FIG. 1 is a flowchart showing a representative process of a microlens array manufacturing method in accordance with an embodiment of the present invention.

FIG. 2 is a schematic cross sectional view showing a part of a microlens array workpiece before an etching process is performed.

FIG. 3 is a top view of a microlens array workpiece before an etching process is performed.

FIG. 4 is a schematic cross sectional view showing a microlens array workpiece with a resist layer remaining during an etching process.

FIG. 5 is a schematic cross sectional view showing a microlens array workpiece without a resist layer during an etching process.

FIG. 6 is a schematic cross sectional view showing a part of a microlens array workpiece after an etching process is performed.

FIG. 7 is a top view of a microlens array workpiece before an etching process is performed.

FIG. 8 is a graph showing a relationship between a flow rate of HBr and a height of a microlens when a mixed gas contains CF₄/C₄F₈/HBr in the ratio of 150/30/x respectively.

FIG. 9 is a graph showing a relationship between a flow rate of HBr and a height of a microlens when a mixed gas contains CF₄/C₄F₈/Ar/HBr in the ratio of 270/30/1000/x respectively.

FIG. 10 is a graph showing a relationship between a flow rate of HBr and a height of a microlens when a mixed gas contains CF₄/C₄F₈/N₂/HBr in the ratio of 270/30/1000/x respectively.

FIG. 11 is a graph showing a relationship between a flow rate of HBr and a height of a microlens when a mixed gas contains CF₄/C₄F₈/N₂/HBr in the ratio of 270/60/1000/x respectively.

FIG. 12 is a graph showing a relationship between a flow rate of HBr and a height of a microlens at a position of a top when a mixed gas contains CF₄/C₄F₈/HBr in the ratio of 240/60/x respectively.

FIG. 13 shows the position of the top of FIG. 12.

FIG. 14 is a schematic cross sectional view showing a part of a microlens array before a microlens is formed in accordance with a conventional method.

FIG. 15 is a schematic cross sectional view showing a part of a microlens array after a microlens is formed in accordance with a conventional method.

### BEST MODE FOR CARRYING OUT THE INVENTION

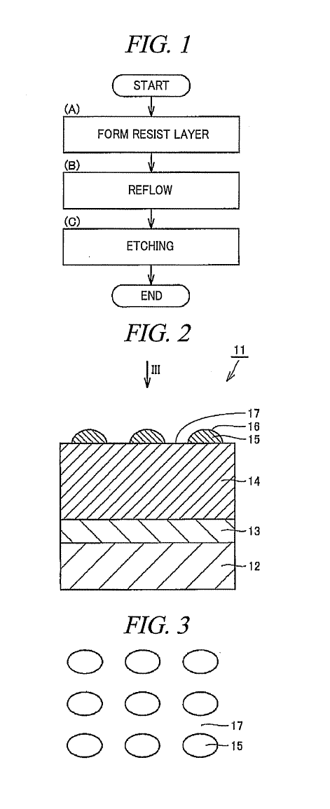

Hereinafter, embodiments of the present invention will be described in detail with reference to the accompanying drawings. FIG. 1 is a flowchart showing a representative process of a microlens array manufacturing method in accordance with an embodiment of the present invention. FIG. 2 is a schematic cross sectional view showing a part of a microlens array workpiece to be described later before an etching process is performed, and FIG. 2 corresponds to FIG. 14. Referring to FIGS. 1 and 2, a microlens array manufacturing method in accordance with an embodiment of the present invention will be explained in detail.

Above all, on a silicon layer 12, a color filter layer 13 made of polystyrene-based resin or polyimide-based resin may be formed. Then, an organic film layer 14 as a material layer of a microlens may be formed thereon. Thereafter, on the organic film layer 14, a resist layer 15 may be formed so as to correspond to an arrangement of multiple microlenses (FIG. 1 (A)). The resist layer 15 may be made of an organic material which can be etched by an etching process to be described later. The resist layer 15 may be first formed in a substantially rectangular cross sectional shape by a lithography technique. Then, a reflow process may be performed on the resist layer 15 so as to have a substantially hemispherical shape according to an outer shape of the microlens (FIG. 1 (B)). Further, FIG. 3 shows a microlens array workpiece 11 after the reflow process, when viewed from a top side, i.e. when viewed from a direction indicated by an arrow III in FIG. 2. A plane of the resist layer 15 may be of a substantially elliptical shape longer in a horizontal direction.

That is, in the microlens array workpiece 11 before the etching process is performed, the silicon layer 12, the color filter layer 13, the organic film layer 14, and the resist layer 15 may be formed in a bottom-up sequence. A reflow process may be performed on the upper surface of the resist layer 15 to have a substantially hemispherical shape. Further, multiple layers may be formed below the silicon layer 12, but illustration and explanation thereof will be omitted for easy understanding.

With respect to the microlens array workpiece 11, an etching process may be performed to etch the resist layer 15 and the organic film layer 14 (FIG. 1 (C)). As the etching process, for example, a plasma etching process may be performed by a microwave plasma etching apparatus using a microwave as a plasma source. The etching process performed by the microwave plasma etching apparatus will be briefly explained. In a processing chamber, an etching target material as a process target substrate, i.e. the microlens array workpiece 11, may be provided. The processing chamber may be depressurized to a certain level. Then, plasma may be generated within the processing chamber by a microwave and an etching gas may be introduced. Thereafter, the etching process may be performed on the etching target material.

In the etching process, a mixed gas including hydrogen-containing molecules and fluorine-containing molecules may be used. As the hydrogen-containing molecules, for example, HBr can be used. As the fluorine-containing molecules, for example, a freon-based gas such as CF₄, C₂F₆, C₃F₈, and C₄F₈ can be used. That is, the fluorine-containing molecules may include multiple freon-based gases represented by structural formula CyFz (y and z are integers greater than or equal to 1). Kinds or components of the hydrogen-containing molecules and the fluorine-containing molecules, and flow rate ratios or supplying method of the hydrogen-containing molecules and the fluorine-containing molecules may be selected in various ways depending on etching conditions, characteristics of a required microlens array and a configuration of an apparatus.

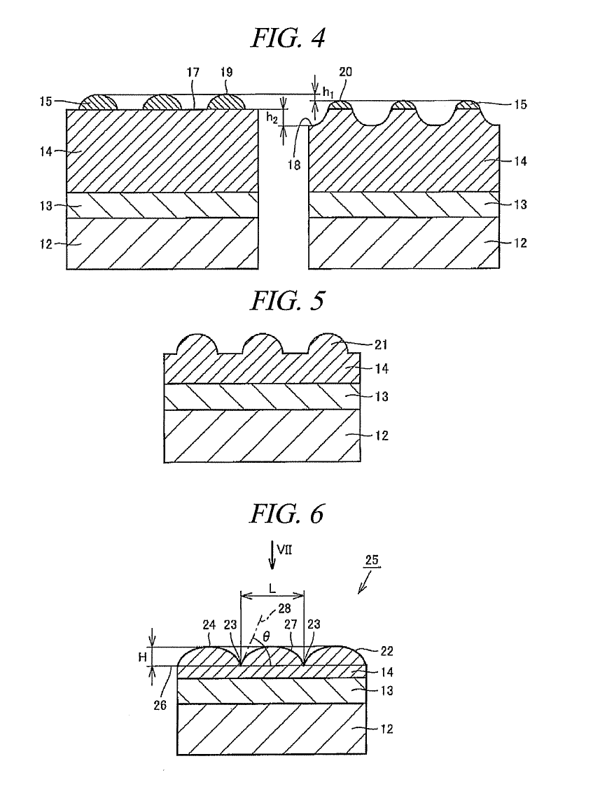

Each of FIGS. 4 and 5 shows a status of the microlens array workpiece 11 during an etching process of a microlens array manufacturing method in accordance with an embodiment of the present invention. FIG. 4 shows that the resist layer 15 remains, and FIG. 5 shows that the resist layer 15 is removed. The cross sections shown in FIGS. 4 and 5 may correspond to the cross section shown in FIG. 2. The etching process may be performed as depicted in FIGS. 2, 4, 5, and FIG. 6 to be described later, in sequence. Further, for easy understanding, FIG. 2 is provided on the left of FIG. 4 such that the silicon layers 12 are arranged at the same position in the vertical direction.

Referring to FIG. 4, while the etching process is performed, in regions where the organic film layer 14 is exposed upwards, the organic film layer 14 may be etched as the etching process proceeds, to be specific, as etching time passes. That is, a position of an upper surface 17 of the organic film layer 14 depicted on the left of FIG. 4 may be shifted downwards to an upper surface 18 of the organic film layer 14 as depicted on the right of FIG. 4. Meanwhile, in regions where the resist layer 15 is formed, the resist layer 15 may be etched from an upper portion. In this case, a position of a vertex 19 protruded the most from the upper portion of the resist layer 15 depicted on the left of FIG. 4 may be shifted to a position of a vertex 20 of the resist layer 15 depicted on the right of FIG. 4. Here, a vertical length denoted by h₁ in FIG. 4 indicating a shift from the vertex 19 of the resist layer 15 to the vertex 20 of the resist layer 15, i.e. a so-called etched amount of the resist layer 15 and a vertical length denoted by h₂ in FIG. 4 indicating a shift from the upper surface 17 of the organic film layer 14 to the upper surface 18 of the organic film layer 14, i.e. a so-called etched amount of the organic film layer 14 can be easily adjusted by a mixed gas, i.e. the mixed gas including the hydrogen-containing molecules and the fluorine-containing molecules for the above-described two reasons. The mixed gas is used in the etching process in the microlens array manufacturing method in accordance with an embodiment of the present invention. To be specific, by way of example, it may become easy to adjust the height h₂ to be greater than the height h₁ such that a required microlens may have a great height.

Thereafter, the resist layer 15 may be completely removed as depicted in FIG. 5. However, in this case, the organic film layer 14 provided below the resist layer 15 in the region, where the resist layer 15 was formed, may remain with a large height in the vertical direction. Thus, the organic film layer 14 may be formed to have a protrusion 21 protruded upwards. In this case, portions corresponding to the vertexes 19 and 20 may be protruded the most upwards.

Thereafter, the etching process may proceed further and may be ended when a required shape can be obtained. By way of example, the etching process may be ended when a vertical length from an upper surface of the color filter layer 13 to a horizontal end 23, which is a lowermost portion on an upper surface of the organic film layer 14, of a microlens 22 reaches a certain length. Otherwise, by way of example, the etching process may be ended when a certain etching time passes after the etching process starts.

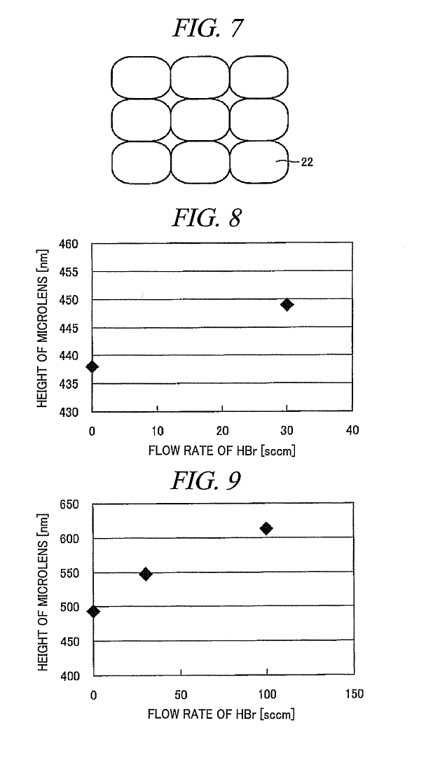

FIG. 6 shows a schematic cross sectional view of a part of a microlens array workpiece manufactured in this way. FIG. 7 is a top view, i.e. when viewed from a direction indicated by an arrow VII in FIG. 6, of the microlens array depicted in FIG. 6.

Referring to FIGS. 6 and 7, a microlens array 25 may include the silicon layer 12, the color filter layer, and the organic film layer 14 in a bottom-up sequence. Further, the microlens array 25 may include multiple microlenses 22 protruded in a substantially hemispherical shape from a surface, i.e. an upper surface herein. A plane of the microlens 22 may be of a substantially elliptical shape longer in a horizontal direction (see FIG. 7). The multiple microlenses 22 may be adjacent to each other. To be specific, some part of horizontal ends 23 of the microlenses 22 may not be separated from each other, and may be closely in contact with each other.

That is, the microlens array in accordance with the present invention may have the multiple microlenses each of which protruded in a substantially hemispherical shape from a surface. On the organic film layer as a material layer of the microlens, the resist layer may be formed to obtain a shape of the microlens. The formed resist layer and the organic film layer may be etched by using the mixed gas including the hydrogen-containing molecules and the fluorine-containing molecules. Thus, the microlens array can be manufactured.

Here, a vertical length H, i.e. a height of the microlens 22, from the horizontal end 23 as a lowermost portion of the microlens 22 in a vertical direction to a vertex 24 as an uppermost portion of the microlens 22, protruded in a substantially hemispherical shape can be adjusted selectively by the above-described microlens array manufacturing method. To be specific, in order to manufacture a microlens having a great height, by way of example, a gas flow rate of the hydrogen-containing molecules may be increased. As a result, it may become easy to manufacture a microlens array including the microlenses having a great height.

With respect to the microlens array manufactured as described above, it may be possible to obtain a vertical length H of about 0.3 μm or higher. Here, the vertical length H is measured from the horizontal end 23 as the lowermost point of the microlens in the vertical direction to the vertex 24 as an uppermost point protruded in a substantially hemispherical shape from the microlens. Further, with respect to the microlens array manufactured as described above, a ratio of the vertical length H to a length L between the horizontal ends 23 may be about 1:5 or at least in a range of about 1:2 to about 1:6. Furthermore, with respect to the microlens array manufactured as described above, when an angle formed by a line 26 extended from the horizontal end 23 of the microlens in a horizontal direction and a tangent line 28 of a spherical surface 27 at the horizontal end 23 of the microlens is denoted by θ, θ may be equal to or greater than about 35 degrees or at least about 30 degrees or more. In FIG. 6, the tangent line 28 is indicted by a dashed dotted line.

As described above, according to the microlens array manufacturing method in accordance with the present invention, it may become easy to manufacture a microlens array including microlenses having a required height.

Further, according to the microlens array in accordance with the present invention, a light collection efficiency can be improved since a vertical height of a microlens is large.

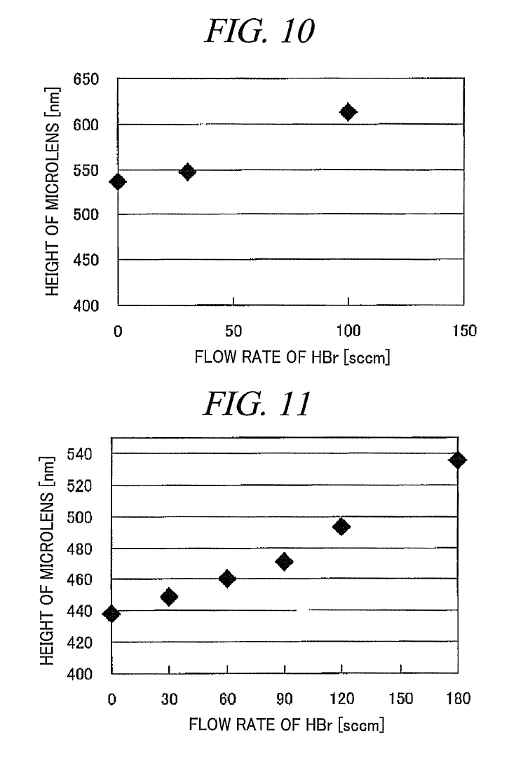

Hereinafter, a microlens array manufactured by the above-described method will be explained. FIGS. 8, 9, 10, and 11 are graphs each showing a relationship between a flow rate of HBr and a height of a microlens, i.e. a vertical length of the microlens. FIG. 8 shows a case where an internal pressure of a processing chamber is about 10 mTorr and the mixed gas as an etching gas contains CF₄/C₄F₈/HBr in a gas flow rate ratio of about 150/30/x. FIG. 9 shows a case where the internal pressure of the processing chamber is about 100 mTorr and the mixed gas as an etching gas contains CF₄/C₄F₈/Ar/HBr in a gas flow rate ratio of about 270/30/1000/x. FIG. 10 shows a case where the internal pressure of the processing chamber is about 100 mTorr and the mixed gas as an etching gas may contain CF₄/C₄F₈/N₂/HBr in a gas flow rate ratio of about 270/30/1000/x. FIG. 11 shows a case where the internal pressure of the processing chamber is about 100 mTorr and the mixed gas as an etching gas contains CF₄/C₄F₈/N₂/HBr in a gas flow rate ratio of 270/60/1000/x. Herein, x denotes a gas flow rate of HBr and is a variable on a horizontal axis shown in the graphs of FIGS. 8 to 11 and FIG. 12. A unit of a gas flow is sccm.

Referring to FIGS. 8, 9, 10, and 11, it can be identified in any of the cases that as a flow rate of HBr is increased, a height of a microlens becomes large too. That is, in any of the flow rate ratios, as a flow rate ratio of HBr is increased, a height of a microlens becomes large too.

Desirably, the internal pressure of the processing chamber during the etching process may be about 200 mTorr or lower. In this way, it may be possible to more reliably adjust a height of a microlens. Further, more desirably, the internal pressure of the processing chamber during the etching process may be about 150 mTorr or lower.

Desirably, a ratio of the hydrogen-containing molecules to the fluorine-containing molecules in the mixed gas may be in a range of from about 1:2 to about 1:15. Thus, it may be possible to more reliably adjust the height of the microlens. Further, more desirably, the ratio of the hydrogen-containing molecules to the fluorine-containing molecules in the mixed gas may be in a range of from about 1:2 to about 1:10.

Desirably, the fluorine-containing molecules may include CF₄ and C₄F₈ and a flow rate ratio of CF₄ to C₄F₈ may be in a range of from about 2:1 to about 10:1. In this range, it may be possible to more reliably adjust the height of the microlens. Further, it is possible to set the flow rate ratio of CF₄ to C₄F₈ to be in a range of from about 2:1 to about 15:1.

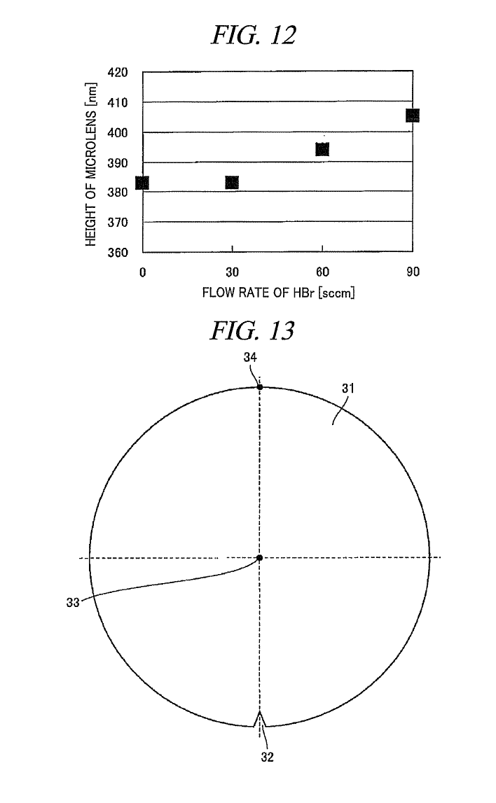

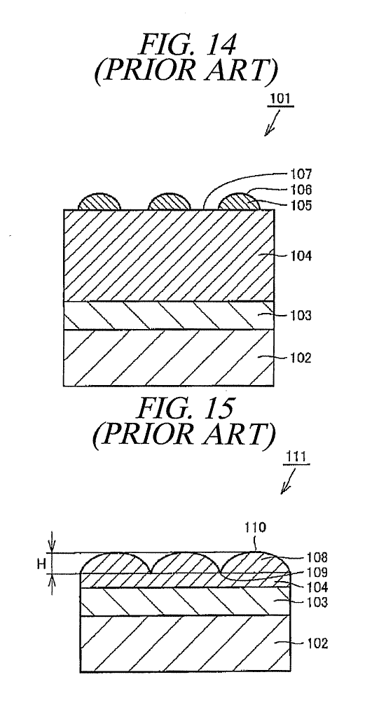

FIG. 12 shows a height of a microlens at a position of a top of a semiconductor substrate serving as an etching target material. Hereinafter, the position of the top will be explained briefly. FIG. 13 shows the position of the top of the semiconductor substrate. Referring to FIG. 13, a position of a top 34 is defined as a position of 180-degree symmetry with respect to a region where a notch 32 is formed with a center 33 serving as the center of the semiconductor substrate 31. The notch determines a certain position in a circumferential direction. That is, the position of the top 34 may be positioned at an end portion farthest away from the center of the semiconductor substrate 31. Referring to FIG. 12, regarding the height of the microlens and the flow rate of HBr at the position of the top 34, the height of the microlens has little difference between a case where the flow rate of HBr is about 30 sccm and a case where HBr is not flowed, i.e. the flow rate of HBr is about 0 sccm. However, if the gas flow rate of HBr is about 30 sccm or higher, the height of the microlens becomes increased. Therefore, the gas flow rate of HBr may be desirable to be about 30 sccm or higher considering the height of the microlens at the position of the top.

In the above-described embodiment, in the resist layer forming process, the resist layer is formed in, but not limited to, a substantially elliptical shape when viewed from a top side. The resist film may be formed in a substantially circular shape when viewed from the top side. Further, a cross sectional shape of the resist layer may have a straight line or an angle as shown in FIG. 2 or the like.

Further, in the above-described embodiment, the horizontal ends of the multiple microlenses may be, but is not limited to, partially in contact with each other. The horizontal ends of the microlens may be arranged so as to be separated from adjacent microlenses.

Furthermore, in the above-described embodiment, the vertex of the microlens may be the most protruded portion from the microlens having a substantially hemispherical shape. However, the vertex may not be positioned at an exact center of the microlens of a substantially hemispherical shape. The above-described vertical direction and horizontal direction may not mean a vertical direction and horizontal direction in a strict sense.

In the above-described embodiment, there may be performed, but not limited to, the plasma etching process using a microwave. Other plasma processes may be employed.

The embodiment of the present invention has been explained with reference to the accompanying drawings, but the present invention is not limited thereto. The above-described embodiment can be changed and modified in various ways within the scope or equivalent scope of the present invention.

### INDUSTRIAL APPLICABILITY

A microlens array manufacturing method and a microlens array in accordance with the present invention can be used efficiently when a microlens of a greater height is demanded.

### Explanation of Codes

11: Microlens array workpiece

12: Silicon substrate

13: Color filter layer

14: Organic film layer

15: Resist layer

16, 17, 18: Upper surfaces

19, 20, 24: Vertexes

23: End

21: Protrusion

22: Microlens

25: Microlens array

26, 28: Lines

27: Spherical surface

31: Semiconductor substrate

32: Notch

33: Center

34: Top

1. A manufacturing method for a microlens array including a plurality of microlenses protruded in a substantially hemispherical shape from a surface, the method comprising:
forming a resist layer for forming a shape of the microlenses on an organic film layer serving as a material layer of the microlenses; and
etching the formed resist layer and the organic film layer by using a mixed gas including hydrogen-containing molecules and fluorine-containing molecules.

2. The microlens array manufacturing method of claim 1, wherein forming a resist layer includes forming the resist layer protruded in a substantially hemispherical shape.

3. The microlens array manufacturing method of claim 1,
wherein in the mixed gas, the hydrogen-containing molecules has a gas flow rate of about 30 sccm or higher.

4. The microlens array manufacturing method of claim 1,
wherein when etching the formed resist layer and the organic film layer, an internal pressure of a processing chamber is about 200 mTorr or lower.

5. The microlens array manufacturing method of claim 1,
wherein in the mixed gas, a ratio of the hydrogen-containing molecules to the fluorine-containing molecules is in a range of from about 1:2 to about 1:15.

6. The microlens array manufacturing method of claim 1,
wherein the hydrogen-containing molecules include HBr.

7. The microlens array manufacturing method of claim 1,
wherein the fluorine-containing molecules include multiple freon-based gases represented by structural formula CxFy (x and y are integers greater than or equal to 1).

8. The microlens array manufacturing method of claim 1,
wherein the fluorine-containing molecules include CF₄ and C₄F₈, and
a flow rate ratio of the CF₄ to the C₄F₈ is in a range of from about 2:1 to about 15:1.

9. The microlens array manufacturing method of claim 1,
wherein etching the formed resist layer and the organic film layer is performed by using microwave plasma of which a plasma source is microwave.

10. (canceled)

11. A microlens array including a plurality of microlenses protruded in a substantially hemispherical shape from a surface,
wherein in each of the microlenses, a vertical length from a horizontal end as a lowermost point in a vertical direction to a vertex as an uppermost point protruded in the substantially hemispherical shape is about 0.3 μm or higher.

12. A microlens array including a plurality of microlenses protruded in a substantially hemispherical shape from a surface,
wherein in each of the microlenses, a ratio of a vertical length to a horizontal length is in a range of from about 1:2 to about 1:6,
the vertical length indicates a height difference between a horizontal end as a lowermost point in a vertical direction and a vertex as an uppermost point protruded in a substantially hemispherical shape, and
the horizontal length indicates a length between the horizontal ends.

13. A microlens array including a plurality of microlenses protruded in a substantially hemispherical shape from a surface,
wherein, when an angle formed by a line extended from a horizontal end of each of the microlenses in a horizontal direction and a tangent line of a spherical surface at the horizontal end of each of the microlenses is denoted by θ, θ is equal to or greater than about 30 degrees.
